(19) United States
(12) Patent Application Publication
(10) Pub. No.: US 2003/0014364 A1
(43) Pub. Date: Jan. 16, 2003

(54) System and method for secure delivery of digital documents to bank members

(76) Inventor: Alexander Altotsky, Beaverton, OR (US)

Correspondence Address: KATRINA CAPITAL MANAGEMENT CORPORATION /, ALEXANDER ALTOTSKY, 8245 SW CONNEMARA TR., BEAVERTON, OR, 97008, US

(21) Appl. No.: 10/160,718

(22) Filed: May 31, 2002

Related U.S. Application Data
(60) Provisional application No. 60/305,702, filed on Jul. 16, 2001.

(51) Int. Cl. G06F 17/60

(52) U.S. Cl. 705/45

(57) ABSTRACT

The present invention provides systems and methods for secure delivery of demand digital documents from Item Processing Center through Online Banking Center to Bank members. A bank member securely login to ‘Online Banking System’. The Online Banking System authenticates member and gives this member access to their online bank account. Member requests digital document from Online Banking System. Online Banking System forwards request to Item Processing Center. Item Processing Center authenticates request and replies with requested digital document. Online Banking System forwards the document to bank member.

### CROSS-REFERENCE TO RELATED APPLICATIONS

This application claims priority of U.S. Provisional Application No. 60/305,702, entitled “System and method for secure delivering digital images of the checks to bank members,” filed on Jul. 16, 2001, the disclosure of which is incorporated fully herein by reference.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### FIELD OF THE INVENTION

This invention generally relates to banking facilities layout and is a method and system for members and bank personnel interaction with online banking products. In particular, these features include access over the Internet to digital documents.

### BACKGROUND OF THE INVENTION

Individuals, businesses, government agencies, and other institutions of all types issue checks and initiate other electronic transactions to make payments in the United States and internationally. For many years, checks were used almost exclusively in the United States for making payments and today still account for the vast majority of payments. There is a well-defined and well-known process within the banking system of the United States that supports checks as a payment mechanism, commonly known as the check clearing process or check clearing system. The U.S. Pat. No. 5,870,725 described clearing process.

The clearing process and equipment is expensive and requires additional trained personnel. For these reasons some banks have separated and outsourced “clearing process” to “Item Processing” institutions where checks are processed and electronically stored. These banks are a majority of Credit Unions financial institutions. The Item Processing institutions are usually Corporate Credit Unions and/or Leagues.

A majority of banks have developed or outsourced online home banking systems. These systems contain member account information and member access information. It is a big challenge for these home-banking systems to incorporate a digital copy of member documents.

There are several existing methods to accomplish this task:

1. The Item Processing Centers use media (CD, DVD, tape . . . ) to deliver digital documents to Online Banking Center. This method is expensive and hard to implement. It requires daily media processing and delivering. The Online Banking Centers are required to have or develop software to read above media.

2. The Item Processing Center allows Online Banking Centers to redirect member's request to Item Processing Center. The Item Processing Centers does not authenticate users. This method is unsecured and may violate bank member privacy.

3. Item processing centers allows an Online Banking Center to redirect a users request to them. Item processing centers authenticate users. It is too expensive to authenticate a bank member at an Item Processing Center. Item Processing Center must have a copy of member's access database and synchronize it with the copy at the Online Banking Center.

4. Item processing centers can e-mail or fax a copy of the document to a member. This is most common practice. Bank member request a copy of the document from bank teller. The bank teller contacts the Item Processing Center and requests a copy of the document. Item Processing Center sends fax to bank member's teller.

### SUMMARY OF THE INVENTION

It is an object of the invention to provide a secure system and method for delivery of a digital document or image, such as a check or statement, to Online Banking users.

It is another object of the invention to provide a secure system and method that utilizes a standard communication protocol to provide an easy to incorporate solution for any Home Banking system.

It is another object of the invention to provide a secure system and method that minimizes violation of bank member's privacy and counteracting fraud.

These and other objects and advantages of the invention may be achieved by a method of securely delivering digital documents.

### BRIEF DESCRIPTION OF THE DRAWINGS

The above and other objects, advantages and features of the invention will be more apparent from the following description taken in conjunction with the accompanying drawings, in which:

FIG. 1 is a diagram showing an image storing and retrieving process at Item Processing Center;

FIG. 2 is a diagram showing the steps of the digital document retrieval process according to the invention;

FIG. 3 is a flow diagram showing the steps of the digital document retrieval process according to the invention;

FIG. 4 is a flow diagram showing the steps in the Check-On-Demand Client verification process according to the invention; and

FIG. 5 is a flow diagram showing the steps in the Check-On-Demand Server verification process according to the invention.

### DETAILED DESCRIPTION OF THE INVENTION

A detailed description of the invention will be provided in detail below with reference to the accompanying figures. The invention provides a way of delivering digital document to an authenticated user of the Online Banking system, which can be incorporated into existing Online Banking system, thereby providing a secured, easy-implemented solution to the financial institutions.

The invention also eliminates the need for increasing the size of the pipe to the Internet, as a document will be retrieved on a demand basis. The invention also provides a simple way to integration with almost any type of Online Banking solutions.

Check imaging and electronic transaction procedure involves the scanning of a paper check by a scanner, which digitizes the image of the check pixel by pixel and stores the image electronically in memory. The image then, may be transferred electronically to substitute for or precede the physical delivery of the check, e.g., to truncate the clearing process. The image of the check may be recreated on a computer monitor or on paper for verification by the appropriate banking institutions.

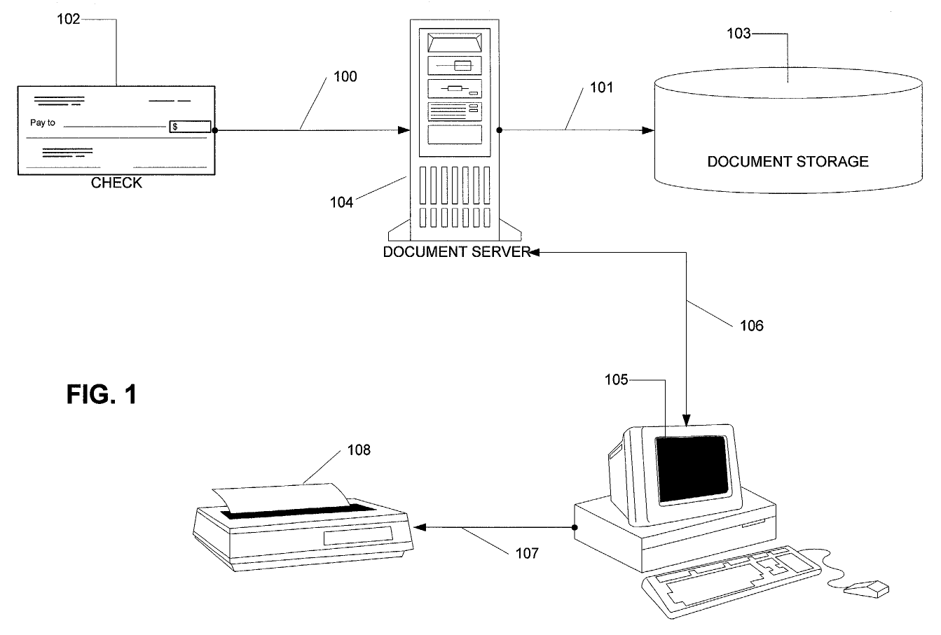

FIG. 1 shows such process. The check (element 102) scanned (process 100) and stored (process 101) on document server (element 104) into documents storage (element 103). Local client (element 105) at Item Processing Center may retrieve (process 106) the image from document server. This image may be printed (process 107 and element 108), faxed or e-mailed to a requester. This is a common practice at most Item Processing Centers. The system at imaging server usually does not allow direct communication with more than one Online Banking system.

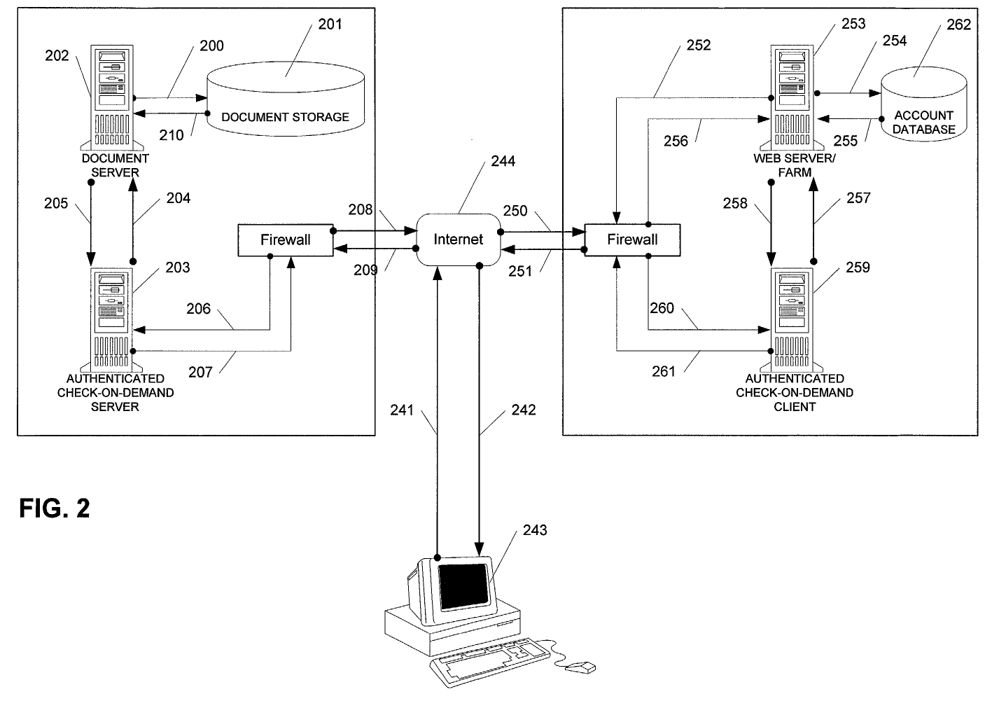

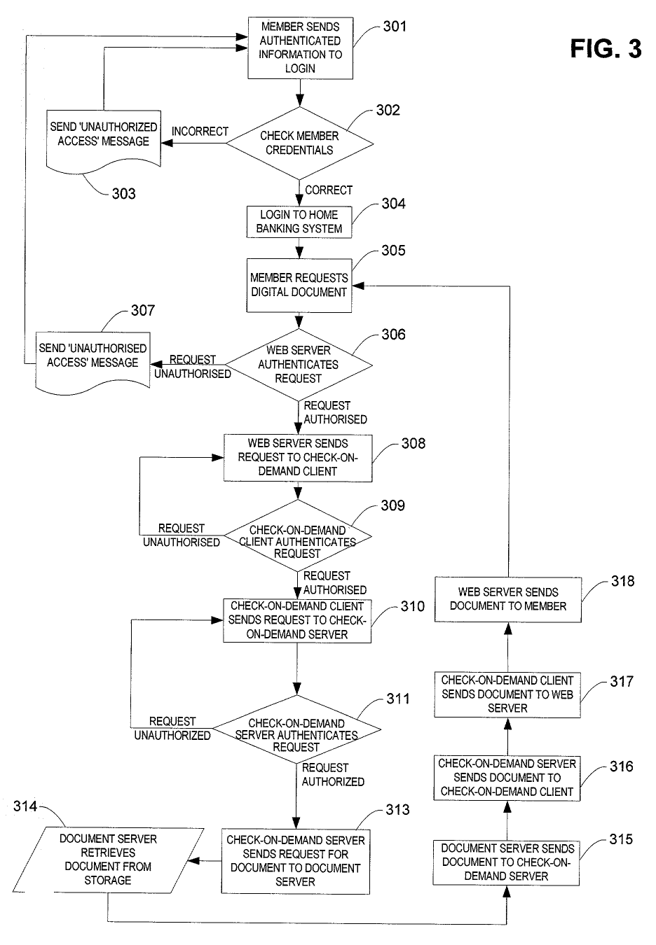

The invention process, showing on FIGS. 2 and 3, eliminates the needs and efforts for a large modification of Online Banking systems or Imaging system.

FIG. 2 in conjunction with FIG. 3 is a graphical representation of the process steps of the invention.

From here forward the notation for elements and processes on figures are the following: FIG. x.abc, where x is the figure number and abc is the element or process number on the figure. A bank member or authorized user (“member”) of Online Banking (FIG. 2.243) sends login request to the Online Banking system (FIGS. 2.242 and 3.301). The request travels through Internet (FIG. 2.244) to web server(s) (FIG. 2.253) at Online Banking Center. The web server verifies (FIGS. 2.245 and 3.302) login information according to the Account Database (FIG. 2.262). The member's request may be rejected (FIG. 3.303) if credentials are incorrect. The correct credentials allow member to use the system freely (FIG. 3.304).

The Online Banking system may use different approaches to direct the user to a digital document retrieval page. As a result of a member navigating to the page that requests a digital document member sends request to the web server (FIG. 3.305). The web server authenticates and validates member request (FIG. 3.306). The unauthorized or invalid request will be rejected (FIG. 3.307). The correct and authorized request will be accepted by web server and forwarded (FIG. 2.258) to Check-On-Demand client. The forwarded request contains all necessary information to correctly identify the requested document. This information usually contains the member account number; document number and other information based on requirements for document server (FIG. 2.202).

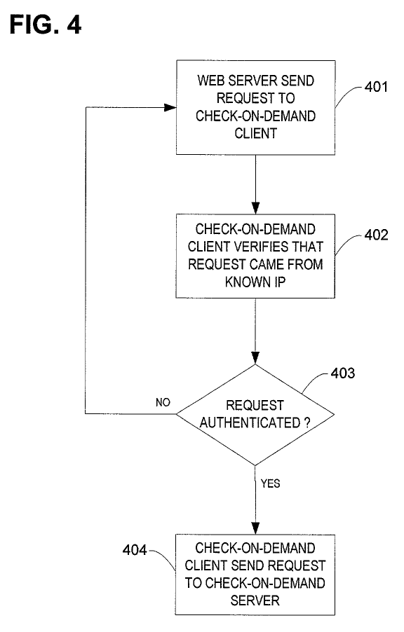

The communication protocol may be as simple as HTTP or HTTPS, encrypted or unencrypted. The communications need to be encrypted if location of the Check-On-Demand Client is not on the separate network with web server. An encryption process is time and bandwidth expensive. For these reasons it wise to put a web server and Check-On-Demand Client on the same network and use HTTP—unencrypted communication. FIG. 4 is a flow diagram describing in greater detail the web server and Check-On-Demand Client communication.

The Check-On-Demand Client must filter all requests by known IP addresses (FIG. 4.402) from Online Banking web servers only (FIG. 4.403). This precaution is a minimum level of security for Check-On-Demand Client and it guarantees that Check-On-Demand Client will send documents only to Online Banking web servers. The Check-On-Demand Client will reject all requests from unauthorized sources (FIG. 4.403). The authorized and valid request will be redirected to Check-On-Demand Server (FIG. 4.404).

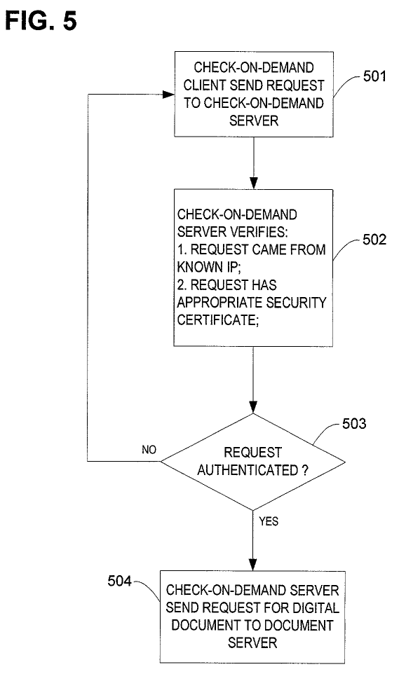

FIG. 5 is a flow diagram described in a grater details Check-On-Demand Client and Check-On-Demand Server communication.

The Check-On-Demand Server must filter all requests by known IP addresses (FIG. 5.502) from Check-On-Demand Clients or subnet where they are located (FIG. 5.503). The Check-On-Demand Client—Server communication must be encrypted. The example of encrypted communication could be HTTPS/SSL or any other encryption protocols. Using client certificate is the third part of minimum safety measures to ensure security in Check-On-Demand Client—Server communication. System administrator may revoke certificate issued by Check-On-Demand Server at any time. In addition to above measure “digest authentication”, network card id and Intel chip id may be used. The Check-On-Demand Server will reject all requests from unauthorized sources (FIG. 5.503). The authorized and valid request will be redirected to Document Server (FIGS. 5.504 and 2.202).

The Document Server (FIG. 2.202) may or may not perform additional validations and authentications based on installed software. This communication (FIGS. 2.204 and 2.205) is considered practically secure because it is done over private network and behind a firewall. Document Server retrieves (FIGS. 2.200, 3.314 and 2.210) digital document from the Document Storage (FIG. 2.201) and forwards it (FIGS. 2.205 and 3.315) to Check-On-Demand Server (FIG. 2.203). The Check-On-Demand Server (FIG. 2.203) forwards digital document as encrypted HTTPS response (FIG. 3.316) to Check-On-Demand Client (FIGS. 2.207, 2.208, 2.250 and 2.260). The Check-On-Demand Client (FIG. 2.259) forwards document as HTTP response (FIG. 2.257) to web server (FIGS. 2.253 and 3.317) that sent the initial request. The web server forwards digital document as an encrypted HTTPS response to member (FIGS. 2.242 and 3.318).

What is claimed is:

1. A system and method delivering a digital document from Item Processing Center, where a digital document is stored, through an Online Banking Center to bank members or bank personnel.

2. The method of claim 1 wherein delivering methods further comprises:
the Internet or the Intranet, or the Extranet, or the VPN, or any other electronic networks.

3. The method of claim 1 wherein communication protocol further comprises:
the TCP/IP or the SSL, or the HTML, or the XML, or the SOAP, or any other network communication protocols.

4. The method of claim 1 wherein bank member comprises of any authorized non-bank personnel that have access to member account.

5. The method of claim 1 wherein bank personnel comprise of any authorized bank personnel that have access to a member's account.

6. The method of claim 1 wherein Online Banking Center comprises of any bank or non-bank facility where electronic equipment stores and contains member's account information.

7. The method of claim 1 wherein Item Processing Center comprises of any bank or non-bank facility where digital documents are stored.

8. The method of claim 1 wherein delivering digital document further comprises of the image of the member check, statement or any other digital document stored in Item Processing Center.
